(19) United States
(12) Patent Application Publication
(10) Pub. No.: US 2007/0105470 A1
(43) Pub. Date: May 10, 2007

(54) Method for manufacturing separator having a high ionic conductivity

(76) Inventors: Gwo-Mei Wu, Tao-Yuan (TW); Chun-Chen Yang, Taishan Shiang (TW); Sheng-Jen Lin, Taipei City (TW); Chi-Neng Huang, Taishan Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/527,515

(22) Filed: Sep. 27, 2006

(30) Foreign Application Priority Data
Nov. 8, 2005 (TW) 94139149

(51) Int. Cl. B32B 5/26

(52) U.S. Cl. 442/239

(57) ABSTRACT

A method for manufacturing a separator having a high ionic conductivity is proposed, in which at least a composite cloth comprising a polypropylene inner layer and a polyethylene outer layer, a polypropylene cloth or a polyethylene cloth is chosen as the substrate. Next, the substrate surface is rinsed to remove impurities. The substrate is then baked. Subsequently, sulfonation is performed to the substrate using concentrated sulfuric acid. The substrate is then rinsed using DI water until the DI water that has rinsed the substrate has a pH value of 6˜7. Finally, the substrate is baked. A separator having a high ionic conductivity can thus be obtained.

### BACKGROUND OF THE INVENTION

1. Field of the Invention

The present invention relates to a method for manufacturing a separator having a high ionic conductivity and, more particularly, to a method for manufacturing a separator having a high ionic conductivity through sulfonation reaction.

2. Description of Related Art

Surface processing of polymer has been widely studied and extensively applied in the biomedical field, among which the physical and chemical processing methods are most appreciated. Because of their high biodegradable inert property, polyethylene (PE) and low density polyethylene (LDPE) are much appreciated in the biomedical field. In 1972, Leininger began to develop surface processing techniques related to blood solubility. He utilized a Heparin anchoring method to fix anticoagulant on the surface of PE to accomplish a high blood-compatibility and a high biodegradable inert property.

Besides, owing to the continually increasing dependence on petroleum in recent years, the storage capacity of petroleum decreases gradually to cause a continual surge of price. In 2005, the price of petroleum has set a record in history of $70 a barrel to directly affect the world economy. Therefore, the demand for alternative energies has become more and more important. The fuel cell is one of the most promising alternative energies in the future. The most important heart material of a fuel cell is an ionic conductive separator. The ionic conductive separator applied to a fuel cell needs to have a very high hydrophilicity so as not to produce a high repellence with reactants to lower the performance of the fuel cell. In 1962, the US DuPont Company successfully developed a per-fluoro-sulfonic acid type proton conducting membrane, which has been used in the Chlor-Alkali industry since 1964 and in hydrogen oxygen fuel cells since 1966. The per-fluoro-sulfonic acid type proton conducting membrane has further been used as the most critical subassembly of long-lifetime high power proton exchange membrane fuel cells. For the manufacture of per-fluoro-sulfonic acid type proton conducting membranes, poly tetra chloro-ethylene is used as the raw material to synthesize per-fluoro-sulfonic fluroxene monomer. The monomers are then polymerized with poly tetra chloro-ethylene to obtain per-fluoro-sulfonic acid resin. The resin is finally used to manufacture the membrane. The membranes after surface processing produced by the DuPont Company are called Nafine™-series membranes.

Another proton exchange membrane material after surface processing is poly ether ether ketone (PEEK). The PEEK is a kind of engineering plastic with a low price and a high heat-resistant characteristic. In order to enhance the proton conductivity of PEEK, excess asymmetric sulfonated groups (—SO₃H) are added into the main chain of polymer to not only facilitate membrane making and hydrophilicity but also reduce the probability of effusion of methyl alcohol, thereby greatly enhancing the performance of fuel cell. Although there are many other surface processing methods such as surface radiation, surface grafting, and so on, the above method of increasing the hydrophilicity by means of surface sulfonation has aroused much attention of people and is predicted to acquire extensive applications.

The present invention aims to propose a method for manufacturing a separator having a high ionic conductivity.

### SUMMARY OF THE INVENTION

An object of the present invention is to provide a method for manufacturing a separator having a high ionic conductivity, in which several sulfonated groups (—SO₃H) are bonded around such a substrate as a polypropylene/polyethylene cloth, a polypropylene cloth or a polyethylene cloth during the sulfonation process and the crystallization degree of the original substrate is changed so as to form a separator having a high ionic conductivity.

Another object of the present invention is to provide a method for manufacturing a separator having a high ionic conductivity, in which a separator with the desired mechanical strength and ionic conductivity can be obtained through control of the sulfonation time.

Another object of the present invention is to provide a method for manufacturing a separator having a high ionic conductivity, which can be widely applied to biomedical systems and energy storage systems such as alkaline electrolysis systems, zinc-air batteries, Ni-MH batteries, Ni—Cd batteries, Ni—Zn batteries, fuel cells and various kinds of capacitors and supercapacitors.

To achieve the above objects, the present invention provides a method for manufacturing a separator having a high ionic conductivity, in which at least a polypropylene/polyethylene cloth, a polypropylene cloth or a polyethylene cloth is chosen as the substrate. Next, the substrate surface is rinsed to remove impurities. The substrate is then baked. Subsequently, sulfonation is performed to the substrate using concentrated sulfuric acid. The substrate is then rinsed using DI water until the DI water that has rinsed the substrate has a pH value of 6˜7. Finally, the substrate is baked. A separator having a high ionic conductivity can thus be obtained.

### BRIEF DESCRIPTION OF THE DRAWINGS

The various objects and advantages of the present invention will be more readily understood from the following detailed description when read in conjunction with the appended drawing, in which:

FIG. 1 is a flowchart of the present invention;

FIG. 2(a) is a diagram showing the structure of a polypropylene/polyethylene (PP/PE) nonwoven cloth;

FIG. 2(b) is a diagram showing the structure of a sulfonated polypropylene/polyethylene (S-PP/PE) separator;

FIG. 3(a) is a diagram showing the structure of a polypropylene (PP) cloth;

FIG. 3(b) is a diagram showing the structure of a sulfonated polypropylene (S-PP) separator;

FIG. 4 is a diagram of a sandwich ionic conductivity test equipment;

FIG. 5 is a Nyquist AC impedance diagram of S-PP/PE separators for different sulfonation time;

FIG. 6 is a Nyquist AC impedance diagram of S-PP separators for different sulfonation time;

FIG. 7 is a comparison diagram of the sulfur atom content of S-PP/PE separators and S-PP separators for different sulfonation time;

FIG. 8 is an IR spectral comparison diagram of S-PP/PE separators for different sulfonation time;

FIG. 9 is an IR spectral comparison diagram of S-PP separators for different sulfonation time;

FIG. 10 is an XRD crystallization degree comparison diagram of S-PP/PE separators for different sulfonation time;

FIG. 11 is an XRD (X-ray diffraction) crystallization degree comparison diagram of S-PP separators for different sulfonation time;

FIG. 12 is a differential scanning calorimeter (DSC) comparison diagram of S-PP/PE separators for different sulfonation time;

FIG. 13 is a thermal gravimetric analysis (TGA) diagram of S-PP/PE separators for different sulfonation time;

FIG. 14 is a stress versus strain comparison diagram of tensile test of S-PP/PE separators for different sulfonation time;

FIG. 15 is a stress versus strain comparison diagram of tensile test of S-PP separators for different sulfonation time;

FIG. 16(a) is a surface topography analysis diagram of a non-sulfonated PP/PE nonwoven cloth acquired by using a scanning electron microscope (SEM) under a magnification ratio of 40;

FIG. 16(b) is a surface topography analysis diagram of an S-PP/PE separator with a sulfonation time of 72 hours acquired by using an SEM under a magnification ratio of 40;

FIG. 17(a) is a surface topography analysis diagram of a non-sulfonated PP cloth acquired by using an SEM under a magnification ratio of 40; and

FIG. 17(b) is a surface topography analysis diagram of an S-PP separator with a sulfonation time of 72 hours acquired by using an SEM under a magnification ratio of 40.

### DETAILED DESCRIPTION OF THE PREFERRED EMBODIMENTS

In the present invention, a composite nonwoven cloth that comprises a polypropylene inner layer and a polyethylene outer layer (using polypropylene/polyethylene or PP/PE nonwoven cloth to mean), a polypropylene cloth (PP) or a polyethylene cloth (PE) is chosen as the substrate to be sulfonated for acquiring a highly ionic conductive separator having sulfonated groups (—SO₃H).

The present invention will be exemplified below with a polypropylene/polyethylene nonwoven cloth (Pp/PE) and a polypropylene cloth (PP) used as the substrate. If the substrate is a polyethylene cloth (PE), the polyethylene can be softened and fused together to make a nonwoven cloth based on the principle of heated softening.

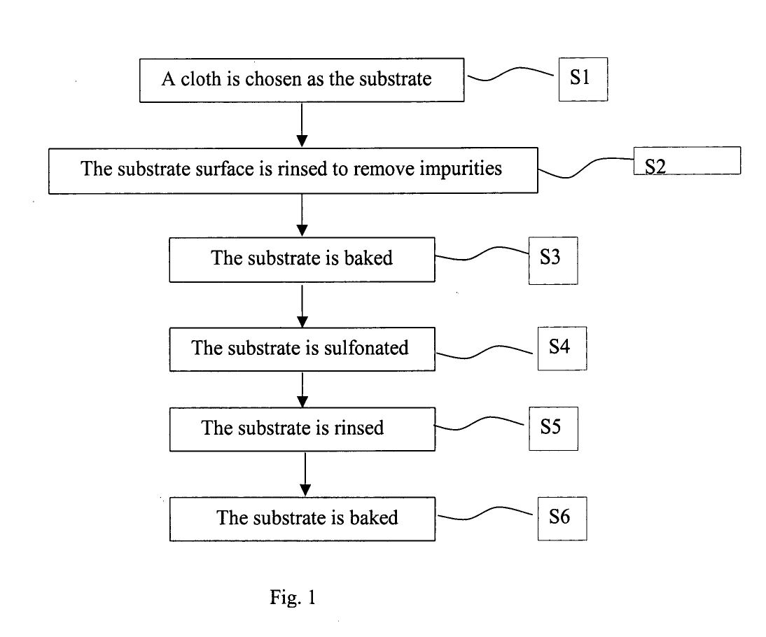

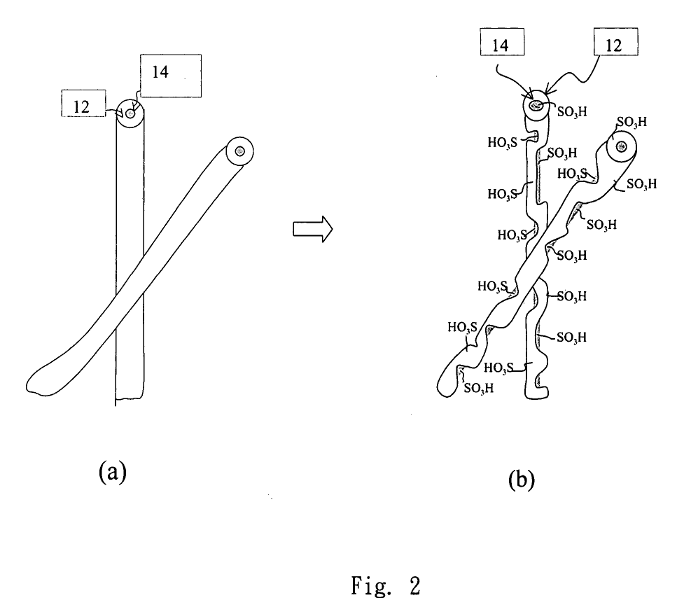

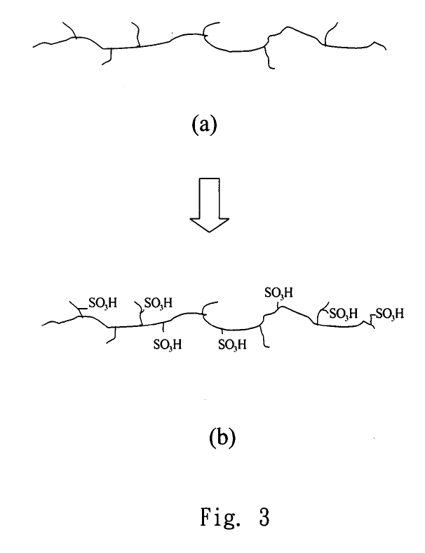

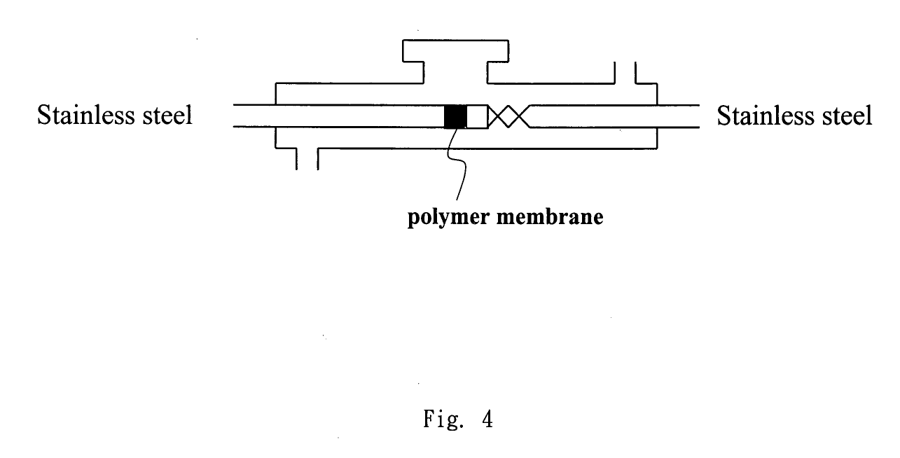

As shown in FIG. 1, the method for manufacturing a separator having a high ionic conductivity of the present invention comprises the following steps. First, a PP/PE nonwoven cloth with a degree of hole of 50˜70% and a thickness of 0.1˜0.2 mm or a PP cloth with a degree of hole of 30˜50% and a thickness of 0.05˜0.2 mm is used as the substrate (Step S1). Next, the surface of the PP/PE nonwoven cloth or the PP cloth as the substrate is rinsed by DI water in a supersonic vibrator to remove impurities on the surface (Step S2). The substrate rinse is then baked in an oven (Step S3). Subsequently, sulfonation is performed to the substrate using concentrated sulfuric acid for 1200 hours under a specific condition so that fluoric acid can infiltrate from the surface into the substrate to achieve full sulfonation (Step S4). The PP/PE nonwoven cloth before and after the sulfonation reaction are shown in FIGS. 2(a) and 2(b), respectively, in which fluoric acid etches the PE shell to damage its crystal structure and forms many sulfonated groups (—SO₃H), and the PP core exposed out of the PE shell also reacts with the fluoric acid to form sulfonated groups (—SO₃H). A PP cloth before and after the sulfonation reaction is shown in FIGS. 3(a) and 3(b), respectively, in which the PP branch structure reacts with fluoric acid to form many sulfonated groups (—SO₃H). The sulfonated PP/PE nonwoven cloth (S-PP/PE) or the sulfonated PP cloth (S-PP) is then rinsed with DI water in a supersonic vibrator for several times until the DI water that has rinsed the substrate has a pH value of 6˜7 (Step S5). Finally, the substrate is baked in a circulation oven at a constant temperature of 60° C. for 72 hours (Step S6). An S-PP/PE separator or an S-PP separator is thus formed.

In order to prove the practicability of the S-PP/PE separator and the S-PP separator manufactured by the present invention; the separator is analyzed as follows. An Instron analyzer is used to test its mechanical tensile strength; A differential scanning calorimeter (DSC) is used to measure the thermal properties and crystallization change of polymer; A thermal gravimetric analyzer (TGA) is used to measure the cracking temperature of solid polymer membrane; A scanning electron microscope (SEM) is used to observe the surface and cross-sectional topography of polymer membrane; and an X-ray diffractometer (XRD) is used to measure the change of crystallization degree of polymer membrane. Besides, after the S-PP/PE separator or the S-PP separator is immersed in a 32 wt % KOH solution for 72 hours and its surface is wiped dry, an AutoLab AC impedance analyzer is then used to measure its ionic conductivity, and a general purpose electrochemical system (GPES) is used to analyze its electrochemical stability and reversibility.

Parameters used in the tests described above are listed below:

(a). Test of ionic conductivity: The ionic conductivity of solid polymer electrolytes is measured with an AutoLab FRA AC impedance analyzer, and bipolar type stainless steel electrodes are used to measure the impedance. The frequency scan range is 1 Hz˜100 kHz, and the amplitude is 10 mV. The membrane thickness, the resistance, and the ionic conductivity are measured. The formula is [s=l/(R_{b}×A)]. The impedance at which the curve intersects the Z′ axis (Z′=R_{b}, and the Z″ (capacitance) value is zero) at the right high-frequency region of a Nyquist diagram is the resistance of the polymer membrane.

(b) Analysis of thermal properties: Thermal properties of solid polymer electrolytes are measured by a TA differential scanning calorimeter (DSC). A polymer sample with a weight of about 5˜10 mg is first compressed into a hermetically sealed aluminum disc, and the measurement is then carried out from 25° C. to 300° C. with a temperature ramp rate controlled to be 10° C. min⁻¹. The thermal cracking temperature is measured by a METTLER thermo gravimetric analysis (TGA)/SVTA851. The sample with a weight of about 5˜10 mg is first loaded into a platinum container, and the measurement is then carried out from 25° C. to 700° C. with a temperature ramp rate controlled to be 10° C. min⁻¹.

(c). Test of mechanical strength: A solid polymer electrolyte membrane is cut into test samples according to the American Society of Testing Materials (ASTM) PART35 standard. An Instron model 5544 universal-testing instrument is used to perform a tensile strength test of membrane with a tensile rate of 100 mm min⁻¹ under a constant temperature. The test result is then plotted with the membrane stress as the y-axis and the membrane strain as the x-axis to obtain a relation curve of the stress and strain of membrane.

(d). Test of crystal strength: The crystal strength of solid polymer electrolytes is measured by a Philips X'Pert X-ray diffractometer. The sample is first dehydrated to make sure there is no influence of water. Under a constant temperature and a constant pressure, the sample is scanned at a rate of 2° min⁻¹ with a 2θ angle from 10°˜60° by Cu Kₐ radiation with a wavelength λ=1.54056 Å.

### Embodiment 1

A PP/PE nonwoven cloth with a degree of hole of 70% and a thickness of 0.2 mm or a PP cloth with a degree of hole of 48% and a thickness of 0.2 mm is selected as the substrate. After the surface of the substrate is rinsed with DI water in a ultrasonic vibrator to remove impurities, the substrate is baked in an oven. Concentrated fluoric acid (18N) then reacts with the substrate in a hermetically sealed environment for 3, 9, 18, 72, and 128 hours so that fluoric acid can infiltrate from the surface into the substrate to achieve full sulfonation. Next, the S-PP/PE cloth or the S-PP cloth is rinsed with DI water in a supersonic vibrator for 30 mins for several times until the DI water that has rinsed the substrate has a pH value of 6˜7. Finally, the substrate is baked in a circulation oven for 72 hours at a constant temperature of 60° C. to obtain an S-PP/PE separator or an S-PP separator.

### Embodiment 2

The S-PP/PE separators and S-PP separators obtained with different sulfonation times in Embodiment 1 (including the PP/PE nonwoven cloth and the PP cloth before sulfonation) are respectively immersed into a 32 wt. % KOH alkaline solution for 72 hours under a constant temperature and a constant pressure. They are then taken out and wiped dry. A digital thickness meter is then used to measure and record their membrane thickness. They are then cut into an area of 1 cm². Bipolar type stainless steel electrodes of an electrochemical impedance analyzer AUTOLAB FRA are used to measure their resistances in a sandwich way (as shown in FIG. 3). The frequency scan range is 1 Hz˜100 kHz, and the amplitude is 10 mV. The membrane thickness, resistance, and ionic conductivity are measured. The formula is [s=l/(R_{b}×A)]. The impedance at which the curve intersects the Z′ axis (Z′=R_{b}, and the Z″ (capacitance) value is zero) at the right high-frequency region of a Nyquist diagram is the resistance of the polymer membrane.

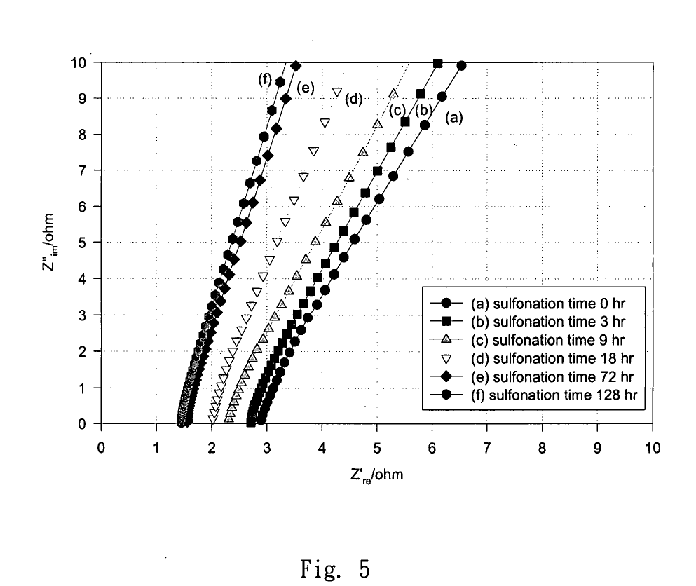

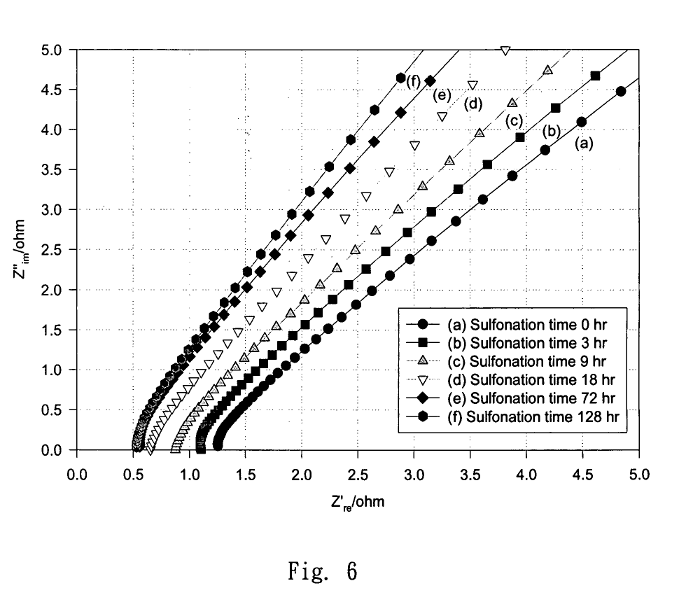

Reference is made to Table 1, FIG. 5 and FIG. 6. From the result, we know that the ionic conductivities of PP/PE nonwoven cloth and PP cloth before sulfonation that have absorbed KOH are 0.0088 S/cm and 0.0152 S/cm, respectively. The ionic conductivity rises with the sulfonation time. After the sulfonation time reaches 72 to 128 hours, the increase of the ionic conductivity slows down. This result shows that sulfonated groups (—SO₃H) are constantly generated on the cloth surface and infiltrate into the inside (FIG. 2(b)) with the increase of the sulfonation time during the sulfonation process of PP/PE nonwoven cloth or PP cloth. Because the sulfonated group (—SO₃H) has poles, the sulfonated cloth thus has an enhanced hydrophilicity. Besides, with the increase of the sulfonated groups (—SO₃H), the probability of coordination with ions (K+, OH—) in the solution increases to facilitate transport of ions, thereby directly proving that the ionic conductivity rises with the sulfonation time.

TABLE 1
a comparison table of the ionic conductivity of S-PP/PE separators
and S-PP separators for different sulfonation times

Separators

| Sulfonation Time(hrs) | S-PP/PE Separators | S-PP Separators |
|---|---|---|
| 0 | 0.0088 | 0.0152 |
| 3 | 0.0094 | 0.0173 |
| 9 | 0.0112 | 0.0218 |
| 18 | 0.0128 | 0.0292 |
| 72 | 0.0163 | 0.0343 |
| 128 | 0.0175 | 0.0352 |

### Embodiment 3

The composition analysis of the S-PP/PE separators and S-PP separators of 10˜20 mg obtained with different sulfonation times in Embodiment 1 are made by using a Perkin-Elmer EA2400 element analyzer under a temperature of 970° C. to know their C, H, N, S compositions. The results are shown in Table 2 and Table 3.

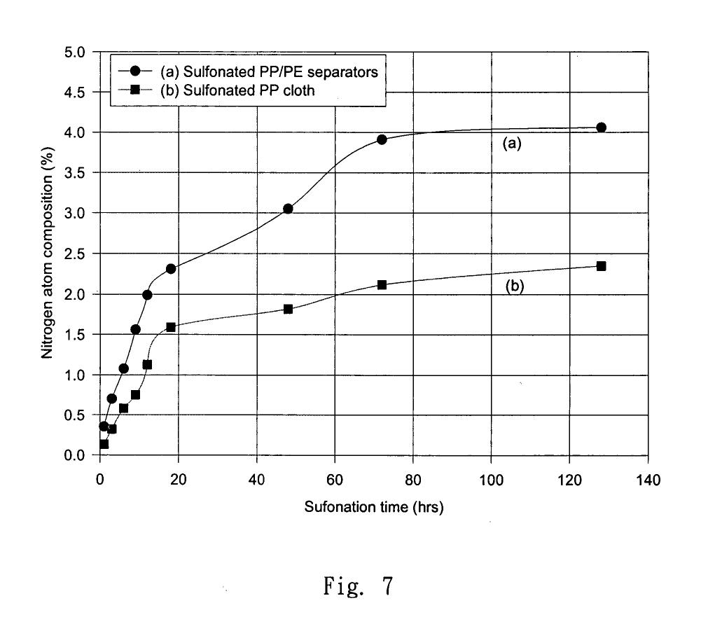

From the results, we know that after the S-PP/PE separators and the S-PP separators have been rinsed with DI water for several times until the DI water that has rinsed them has a pH value of 6˜7, there is no existence of fluoric acid. Therefore, after burning at 970° C., the weight percentage of sulfur element to the original weight of the sample rises from 0.35 wt. % for a sulfonation time of 1 hour to 4.06 wt. % for a sulfonation time of 128 hours. It is also noted that the rise of sulfur element tends to be smoother after a sulfonation time of 72 and 128 hours, as shown in FIG. 6, meaning that the reaction tends to be complete. This result can also be proven from the change of ionic conductivity in Embodiment 1, as shown in FIG. 7. The rise of the ionic conductivity also tends to be smoother after a sulfonation time of 72 and 128 hours. This phenomenon can explain the relationship between sulfonated groups and ionic conductivity. Because the PP/PE nonwoven cloth and the PP cloth have no sulfur element, the increase of sulfur element means that the number of sulfonated groups rises with the sulfonation time. The IR function group scanning of the next embodiment can more completely and clearly prove that the increase of sulfur element means the increase of sulfonated groups.

TABLE 2
analysis results of the element analyzer of S-PP/PE separators for
different sulfonation times

elements

| | | | |
|---|---|---|---|
| C | H | N | S |

| | |
|---|---|
| Sulfonation Time(hrs) | Wt. % |

| | | | | |
|---|---|---|---|---|
| 1 | 79.92 | 13.91 | 0.19 | 0.35 |
| 3 | 82.85 | 13.51 | 0.25 | 0.70 |
| 6 | 80.18 | 12.56 | 0.14 | 1.08 |
| 9 | 78.85 | 11.85 | 0.18 | 1.56 |
| 12 | 83.16 | 10.27 | 0.29 | 1.99 |
| 18 | 80.39 | 10.15 | 0.17 | 2.31 |
| 48 | 84.67 | 9.89 | 0.24 | 3.05 |
| 72 | 81.53 | 10.21 | 0.22 | 3.91 |
| 128 | 78.32 | 8.48 | 0.04 | 4.06 |

TABLE 3
analysis results of the element analyzer of S-PP separators for
different sulfonation times

elements

| | | | |
|---|---|---|---|
| C | H | N | S |

| | |
|---|---|
| Sulfonation Time(hrs) | Wt. % |

| | | | | |
|---|---|---|---|---|
| 1 | 97.63 | 9.21 | 0.07 | 0.13 |
| 3 | 86.33 | 10.17 | 0.12 | 0.32 |
| 6 | 87.25 | 10.68 | 0.09 | 0.58 |
| 9 | 85.74 | 9.72 | 0.23 | 0.75 |
| 12 | 88.21 | 9.93 | 0.18 | 1.13 |
| 18 | 86.38 | 10.23 | 0.27 | 1.59 |
| 48 | 86.59 | 9.89 | 0.09 | 1.82 |
| 72 | 86.41 | 10.08 | 0.11 | 2.12 |
| 128 | 85.48 | 9.56 | 0.15 | 2.35 |

### Embodiment 4

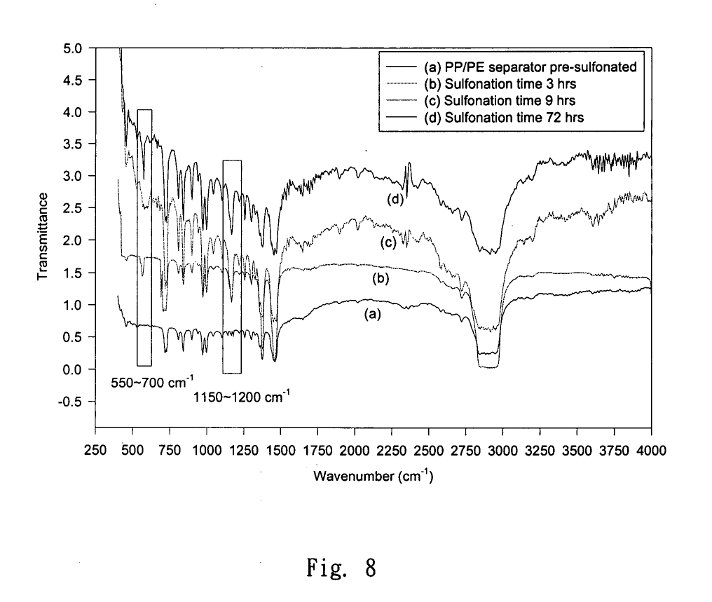

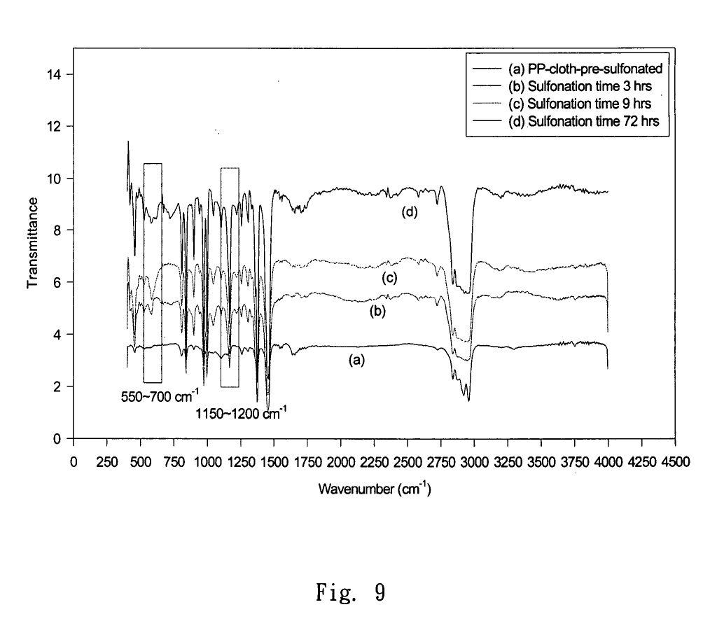

Scanning analysis of function groups of the S-PP/PE separators and S-PP separators obtained with different sulfonation times in Embodiment 1 (including the PP/PE nonwoven cloth and the PP cloth before sulfonation) are respectively performed by using a Nicolet IR spectrometer within the wavelength range of 250˜4000 cm⁻¹. The results are shown in FIGS. 8 and 9. From the results, we know that, regardless of the S-PP/PE separators or the S-PP separators, there is an evident peak within the wavelength ranges of 1150˜1200 cm⁻¹ and 550˜700 cm⁻¹, and the magnitude of the peak rises with the sulfonation time. It is also noted that there is no peak within these wavelength ranges for both the non-sulfonated PP/PE nonwoven cloth and PP cloth. After comparison with standard IR spectrum, it is proven that the peaks generated within these two wavelength ranges correspond to the sulfonated groups (R—SO₃H). This also directly manifests the increase phenomenon of sulfur element analyzed by the element analyzed discussed in Embodiment 3.

### Embodiment 5

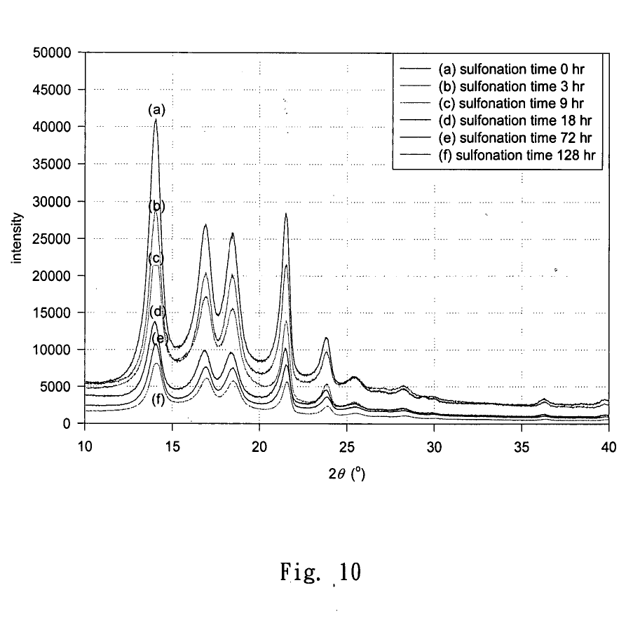

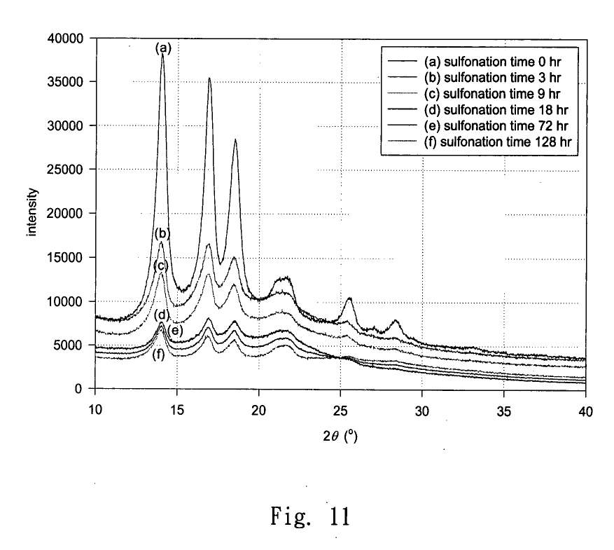

The S-PP/PE separators and S-PP separators obtained with different sulfonation times in Embodiment 1 (including the PP/PE nonwoven cloth and the PP cloth before sulfonation) are respectively dried for 36 hours at a constant temperature of 40° C. The dried separators are then pasted onto a 6×2 cm² glass plate for crystal strength test of solid polymer electrolytes. The crystal strength test is carried out by using a Philips X'Pert X-ray diffractometer. The sample is first dehydrated to make sure there is no influence of water. Next, under a constant temperature and a constant pressure, the sample is scanned at a rate of 2° min⁻¹ with a 2θ angle from 10°˜60° by Cu Kₐ radiation with a wavelength λ=1.54056 Å. The results are shown in FIGS. 10 and 11. For example, from the results of S-PP/PE separators with different sulfonation times, we know that the strongest peak occurs at 14°, and the magnitude of the peak drops with the sulfonation time, especially for the sulfonation time of 18 hours. Besides, the peaks at other different angles also show the same phenomenon. Because the S-PP separators have branch structures, they react with sulfuric acid to form sulfonated groups more easily, as shown in FIGS. 3(a) and 3(b), and apparent drop of the crystallization degree of the PP cloth happens after 3 hours of sulfonation. This result not only explains that the crystallization degree of the PP/PE nonwoven cloth and PP cloth is apparently damaged during the sulfonation process, but also displays a very good phenomenon for the separators with ionic conductivity because damage of the crystallization degree decreases the conduction barrier of ions in material, hence enhancing the ionic conductivity. This phenomenon also illustrates the relationship between decrease of the crystallization degree and increase of the ionic conductivity discussed in Embodiment 2.

### Embodiment 6

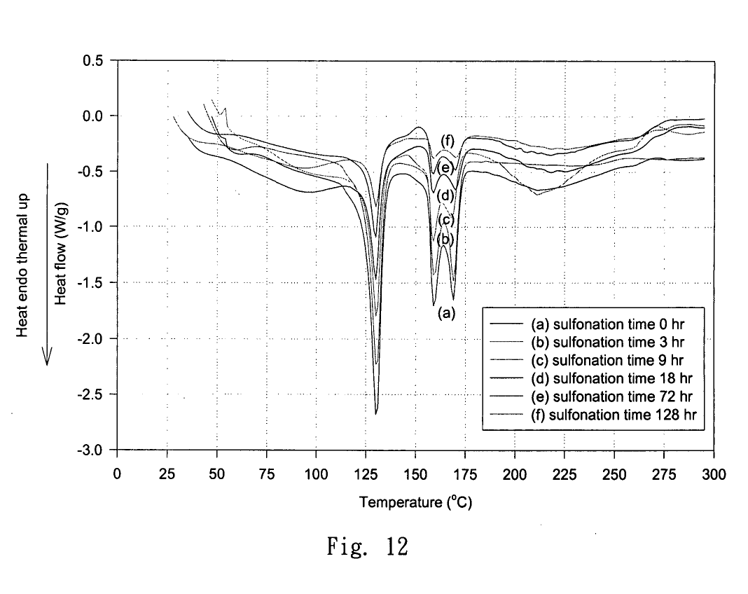

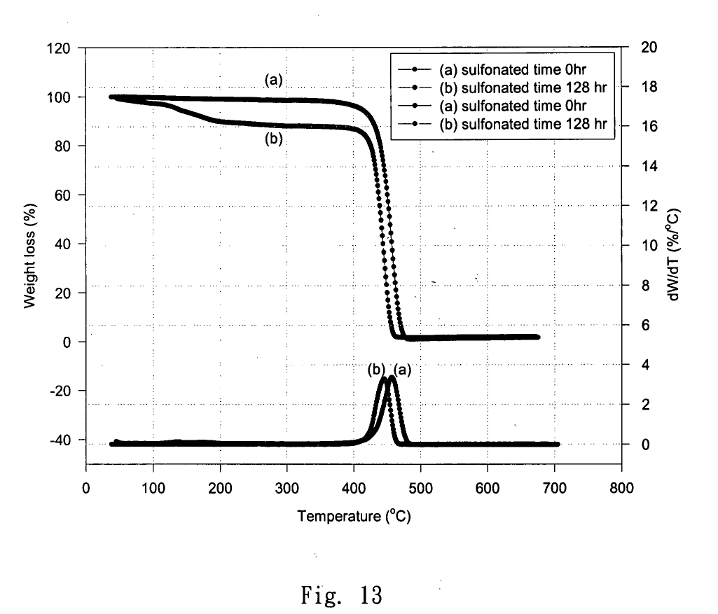

The S-PP/PE separators and S-PP separators obtained with different sulfonation times in Embodiment 1 (including the PP/PE nonwoven cloth and the PP cloth before sulfonation) are respectively dried for 36 hours at a constant temperature of 40° C. Thermal properties of the dried separators are then measured by using a TA DSC Pyris differential scanning calorimeter. The dried polymer membrane sample of about 5˜10 mg is first compressed into a hermetically sealed aluminum disc, and the measurement is then carried out from 25° C. to 300° C. with a temperature ramp rate controlled to be 10° C. min⁻¹. The thermal cracking temperature is measured by a METTLER thermo gravimetric analysis (TGA)/SVTA851. The sample with of about 5˜10 mg is first loaded into a platinum container, and the measurement is then carried out from 25° C. to 700° C. with a temperature ramp rate controlled to be 10° C. min⁻¹. The results are shown in FIGS. 12 and 13.

From the results of the S-PP/PE separators shown in FIG. 12, we know that the non-sulfonated PP/PE nonwoven cloth generates three heat absorption peaks (i.e., the melting points, Tₘ). This proves that it is a material with crystal structure. After reactions of different sulfonation times, the magnitudes of the heat absorption peaks (the melting points) change apparently. That is, the magnitude of the heat absorption peaks (the melting points) drop with the sulfonation time, representing that the crystal structure has been damaged. This phenomenon also directly proves the result of the XRD crystallization degree test discussed in Embodiment 5. From the TGA results shown in FIG. 13, we know that the thermal cracking temperature of the non-sulfonated PP/PE nonwoven cloth is about 470˜480° C. After sulfonation for 128 hours, the thermal cracking temperature drops to about 450° C. This result shows that the S-PP/PE separators have good capabilities to resist thermal cracking in high-temperature environments.

### Embodiment 7

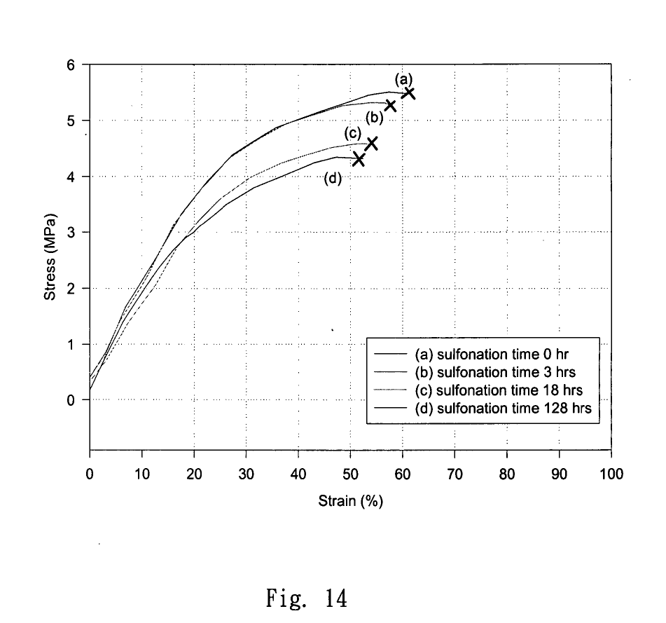

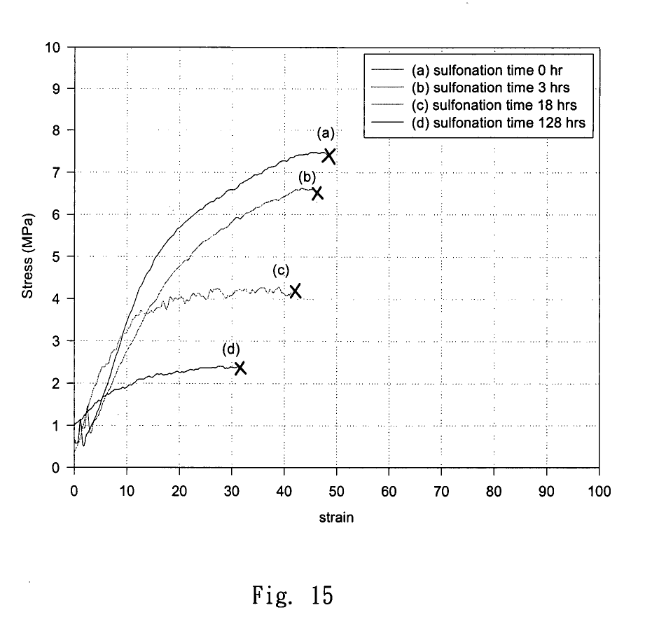

The S-PP/PE separators and S-PP separators obtained with different sulfonation times in Embodiment 1 (including the PP/PE nonwoven cloth and the PP cloth before sulfonation) are respectively dried for 36 hours at a constant temperature of 40° C. Tensile test of the dried membranes is then carried out by using the ASTM method. The mechanical strength of the polymer membrane is measured to show its applicability in industry. The results are shown in Table 4, Table 5, FIG. 14, and FIG. 15.

TABLE 4
a comparison table of tensile properties of the S-PP/PE separators
for different sulfonation times at 25° C.

| | Items | | | | |
|---|---|---|---|---|---|
| | | | | Break | |
| Sulfonation | Thickness | Width | | stress | |
| Time(hrs) | (mm) | (mm) | Area(mm²) | (MPa) | Strain(%) |
| 0 | 0.2 | 15 | 3 | 5.47 | 61 |
| 3 | 0.2 | 15 | 3 | 5.25 | 58 |
| 9 | 0.2 | 15 | 3 | 5.12 | 57 |
| 18 | 0.2 | 15 | 3 | 4.58 | 54 |
| 72 | 0.2 | 15 | 3 | 4.39 | 54 |
| 128 | 0.2 | 15 | 3 | 4.32 | 52 |

TABLE 5
a comparison table of tensile properties of the S-PP separators for
different sulfonation times at 25° C.

| | Items | | | | |
|---|---|---|---|---|---|
| | | | | Break | |
| Sulfonation | Thickness | Width | | stress | |
| Time(hrs) | (mm) | (mm) | Area(mm²) | (MPa) | Strain(%) |
| 0 | 0.15 | 15 | 2.25 | 7.32 | 57 |
| 3 | 0.15 | 15 | 2.25 | 6.64 | 49 |
| 9 | 0.15 | 15 | 2.25 | 5.87 | 47 |
| 18 | 0.15 | 15 | 2.25 | 4.29 | 43 |
| 72 | 0.15 | 15 | 2.25 | 3.65 | 35 |
| 128 | 0.15 | 15 | 2.25 | 2.29 | 32 |

From Tables 4 and 5, we know that after the PP/PE nonwoven cloth or the PP cloth are sulfonated, its cracking strength drops apparently with the sulfonation time. This phenomenon can be explained with damage in the crystal structure (the conclusion of Embodiment 5). The results of Embodiment 7 can match with the results of the ionic conductivity discussed in Embodiment 2 to find a balance point so as to meet the requirements in mechanical strength and also obtain a high ionic conductivity.

### Embodiment 8

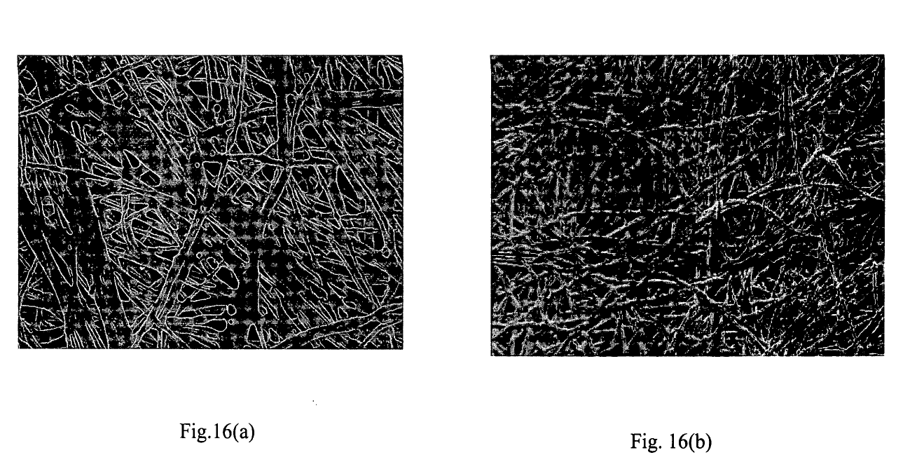

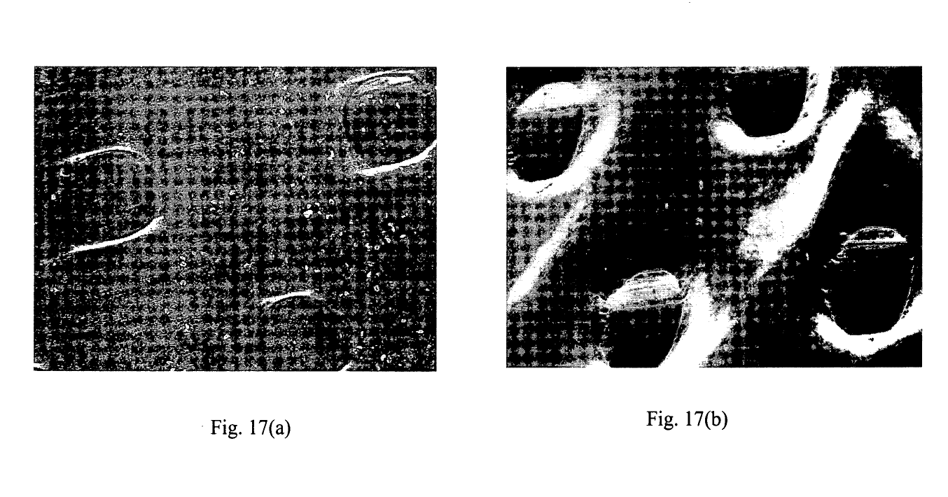

The S-PP/PE separators and S-PP separators obtained with different sulfonation times in Embodiment 1 (including the PP/PE nonwoven cloth and the PP cloth before sulfonation) are respectively dried for 36 hours at a constant temperature of 40° C. The surface topography of the dried separators is then carried out by using a Hitachi S-2600 scanning electron microscope (SEM). FIG. 16(a) is a surface topography analysis diagram of a non-sulfonated PP/PE nonwoven cloth under a magnification ratio of 40. From the figure, we know that the PP/PE nonwoven cloth is a cloth with fibers of different thickness and agrees with the structure shown in FIG. 2(a). FIG. 16(b) is a surface topography analysis diagram of an S-PP/PE separator with a sulfonation time of 72 hours under a magnification ratio of 40. The original fibers of different thickness are fiercely etched during the sulfonation process to become very thin, and the gaps between fibers become larger. This phenomenon agrees with the structure diagram of FIG. 2(b). The mechanical strength of the sulfonated separators is thus reduced. FIG. 17(a) is a surface topography analysis diagram of a non-sulfonated PP cloth under a magnification ratio of 40. From the figure, we know that the PP cloth has circular hole structures with a diameter of about 0.8˜1 mm. FIG. 17(b) is a surface topography analysis diagram of an S-PP separator with a sulfonation time of 72 hours under a magnification ratio of 40. We find there is little change in structure after comparing the structure and size of the circular holes before and after sulfonation.

To sum up, the present invention proposes a method for manufacturing separators having a high ionic conductivity, in which the ionic conductivity of the PP/PE nonwoven cloth and the PP cloth is changed. Through control of the sulfonation time, a balance between mechanical strength and ionic conductivity can be acquired for separators having a high ionic conductivity. Moreover, because the separators manufactured by the present invention have a very good ionic conductivity and hydrophilicity, they can apply to biomedical systems and energy storage systems such as alkaline electrolysis systems, zinc-air batteries, Ni-MH batteries, Ni—Cd batteries, Ni—Zn batteries, fuel cells and various kinds of capacitors and supercapacitors.

Furthermore, the separator manufactured by the present invention can be combined with a polyvinyl alcohol (PVA) having a molecular weight of 20,000˜200,000 to form a composite separator. The separator can also be combined with a polyvinylene oxide (PEO) having a molecular weight of 20,000˜200,000 to form a composite separator. The separator can also be combined with a polyacrylic acid (PAA) having a molecular weight of 5,000˜200,000 to form a composite separator.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore all such substitutions and modifications are intended to be embraced within the scope of the invention as defined in the appended claims.

I claim:

1. A method for manufacturing a separator having a high ionic conductivity comprising the steps of:
choosing more than one cloth as a substrate, said cloth being selected among a composite cloth that comprises a polypropylene inner layer and a polyethylene outer layer, a polypropylene cloth or a polyethylene cloth;
rinsing a surface of said substrate surface to remove impurities, and then baking said substrate;
performing sulfonation to said substrate using concentrated sulfuric acid;
rinsing said substrate using DI water until said DI water that has rinsed said substrate has a pH value of 6˜7; and
baking said substrate to obtain a separator.

2. The method for manufacturing a separator having a high ionic conductivity as claimed in claim 1, wherein a supersonic vibrator is used for rinse with DI water in said steps of rinsing said substrate.

3. The method for manufacturing a separator having a high ionic conductivity as claimed in claim 1, wherein a circulation oven is used to bake said substrate under a constant temperature of 60° C. for 72 hours in said step of baking said substrate to obtain a separator.

4. The method for manufacturing a separator having a high ionic conductivity as claimed in claim 1, wherein said composite cloth has a degree of hole of 20%˜80% and a thickness of 0.05˜0.5 mm.

5. The method for manufacturing a separator having a high ionic conductivity as claimed in claim 1, wherein said polypropylene cloth has a degree of hole of 20%˜70% and a thickness of 0.02˜0.5 mm.

6. The method for manufacturing a separator having a high ionic conductivity as claimed in claim 1, wherein the concentration of said concentrated sulfuric acid is 0.5N˜18N.

7. The method for manufacturing a separator having a high ionic conductivity as claimed in claim 1, wherein the time of sulfonation is 1˜200 hours.

8. The method for manufacturing a separator having a high ionic conductivity as claimed in claim 1, wherein said composite cloth is a nonwoven cloth.

9. The method for manufacturing a separator having a high ionic conductivity as claimed in claim 1, wherein said separator can be applied in energy storage systems such as alkaline electrolysis systems, zinc-air batteries, Ni-MH batteries, Ni—Cd batteries, Ni—Zn batteries, fuel cells and various kinds of capacitors and supercapacitors.

10. The method for manufacturing a separator having a high ionic conductivity as claimed in claim 1, wherein said separator can be combined with a polyvinyl alcohol (PVA) having a molecular weight of 20,000˜200,000 and a degree of hydrolysis of 70˜99% to form a composite separator.

11. The method for manufacturing a separator having a high ionic conductivity as claimed in claim 1, wherein said separator can be combined with a polyvinylene oxide (PEO) having a molecular weight of 20,000˜200,000 to form a composite separator.

12. The method for manufacturing a separator having a high ionic conductivity as claimed in claim 1, wherein said separator can be combined with a polyacrylic acid (PAA) having a molecular weight of 5,000˜200,000 and a degree of hydrolysis of 70˜99% to form a composite separator.
